(19) United States
(12) Patent Application Publication
(10) Pub. No.: US 2026/0107183 A1
(43) Pub. Date: Apr. 16, 2026

(54) WIRELESS COMMUNICATION METHOD AND RELATED DEVICES

(71) Applicant: SHENZHEN TCL NEW TECHNOLOGY CO., LTD., Shenzhen, Guangdong (CN)

(72) Inventor: Yiwei Deng, Shenzhen, Guangdong (CN)

(73) Assignee: SHENZHEN TCL NEW TECHNOLOGY CO., LTD., Shenzhen, Guangdong (CN)

(21) Appl. No.: 19/116,852

(22) PCT Filed: Sep. 30, 2022
(86) PCT No.: PCT/CN2022/123520

§ 371 Date: Mar. 28, 2025

(51) Int. Cl. H04W 28/02; H04L 27/26; H04W 72/1263; H04W 72/21

(52) U.S. Cl. CPC H04W 28/0278; H04L 27/2607; H04W 72/1263; H04W 72/21

(57) ABSTRACT

A wireless communication method and related devices are provided. The method, performed by a user equipment (UE), including transmitting a signaling for requesting uplink resources, wherein the signaling carries information for indicating buffer size information or traffic type or Buffer Status Report (BSR) table type information or resource requesting information; and transmitting data on the requested uplink resources scheduled based on the indicated buffer size information or traffic type or BSR table type information. With this method, data can be transmitted right after SR, thereby reducing scheduling delay.

### TECHNICAL FIELD

The present application relates to wireless communication technologies, and more particularly, to a wireless communication method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

EXtended Reality (XR) and Cloud Gaming are some of the most important 5G media applications under consideration in the industry. The XR is an umbrella term for different types of realities and refers to all real-and-virtual combined environments and human-machine interactions generated by computer technology and wearables. It includes representative forms such as Augmented Reality (AR), Mixed Reality (MR) and Virtual Reality (VR) and the areas interpolated among them. A new Study Item Description (SID) on XR evaluation has been agreed, the characteristics of XR traffic and challenges are summarized below:

High Data Rate with Limited Latency

For 3D VR videos with high resolution based on different frame rates, color codecs, bit-depths, compression rates and etc., the transmission data rate could be up to 60 Mbps and above with limited latency, around 10˜30 ms. In addition, the frame size varies with time. In the field of video compression, three major frame types are defined through three different video algorithms with the following characteristics:
I-frames are the least compressible which can decode independently
P-frames can use previous frames to decompress and are more compressible than I-frames.
B-frames can use both previous and forward frames to get the highest amount of data compression.
   Non-Integer Period with Jitter

It has been agreed that 60 frames per second (fps) is baseline for both Downlink (DL) and Uplink (UL) video stream and 30 fps, 90 fps as well as 120 fps can be also optionally evaluated. Based on the formula of arrival time of packets, the corresponding periodicities are {33.33 ms, 16.67 ms, 11.11 ms, 8.33 ms}. In addition, there exists jitter characteristic for XR traffic arrival. According to previous RANI agreements, the jitter can be modeled as truncated Gaussian distribution with varying range of [−4, 4] ms (baseline) or [−5, 5] ms (optional).

### Multiple Flows

For an XR application, there might be multiple data streams. Three multi-streams models for XR downlink (DL) traffic are provided in clause 5.1.2 of 3GPP TR 38.838, including sliced-based traffic, Group-Of-Picture (GOP) based traffic and so on. And three different multi-streams for AR UL traffic are also provided in clause 5.5.2 of 3GPP TR 38.838. Multiple streams may have different traffic characteristics, Quality of Service (QoS) requirements and priorities.

There is a need to solve the problems raised when merging the XR services into cellular wireless communication, especially for XR service transmission in New Radio (NR).

### SUMMARY

The objective of the present application is to provide a wireless communication method and related devices for solving issues in the prior arts, reducing scheduling delay, achieving accurate granularity of buffer size report, or providing good communication performance.

In a first aspect, an embodiment of the present application provides a wireless communication method, performed by a user equipment (UE) in a network, the method including: transmitting a signaling for requesting uplink resources, wherein the signaling carries information for indicating buffer size information or traffic type or BSR table type information or resource requesting information; and transmitting data on the requested uplink resources scheduled based on the indicated buffer size information or traffic type or BSR table type information.

In a second aspect, an embodiment of the present application provides a wireless communication method, performed by a base station (BS) in a network, the method including: receiving a signaling used to request uplink resources, wherein the signaling carries information for indicating buffer size information or traffic type or BSR table type information or resource requesting information; and receiving data transmitted on the requested uplink resources scheduled based on the indicated buffer size information or traffic type or BSR table type information.

In a third aspect, an embodiment of the present application provides a UE, including a processor and a transmitter, wherein the processor is configured to call and run program instructions stored in a memory, to cooperate with the transmitter to execute the method of the first aspect.

In a fourth aspect, an embodiment of the present application provides a BS, including a processor and a transmitter, wherein the processor is configured to call and run program instructions stored in a memory, to cooperate with the transmitter to execute the method of the second aspect.

In a fifth aspect, an embodiment of the present application provides a computer readable storage medium provided for storing a computer program, which enables a computer to execute the method of any of the first to the second aspects.

In a sixth aspect, an embodiment of the present application provides a computer program product, which includes computer program instructions enabling a computer to execute the method of any of the first to the second aspects.

In a seventh aspect, an embodiment of the present application provides a computer program, when running on a computer, enabling the computer to execute the method of any of the first to the second aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating a SR-BSR-PUSCH procedure according to existing arts.

FIG. 2 is a schematic block diagram illustrating a communication network system according to the present application.

FIG. 3 is a flowchart of a wireless communication method according to the present application.

FIG. 4 is a schematic diagram illustrating an example of PUCCH format 1 with SR and HARQ-ACK overlapped in time domain according to the present application.

FIG. 5 is a schematic diagram illustrating another example of PUCCH format 1 with SR and HARQ-ACK overlapped in time domain according to the present application.

FIG. 6 is a schematic diagram illustrating still another example of PUCCH format 1 with SR and HARQ-ACK overlapped in time domain according to the present application.

FIG. 7 is a schematic diagram illustrating buffer size and traffic type information associated with time and/or frequency resources according to the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

Following issues are identified for service traffic such as Extended Reality (XR) service transmission.

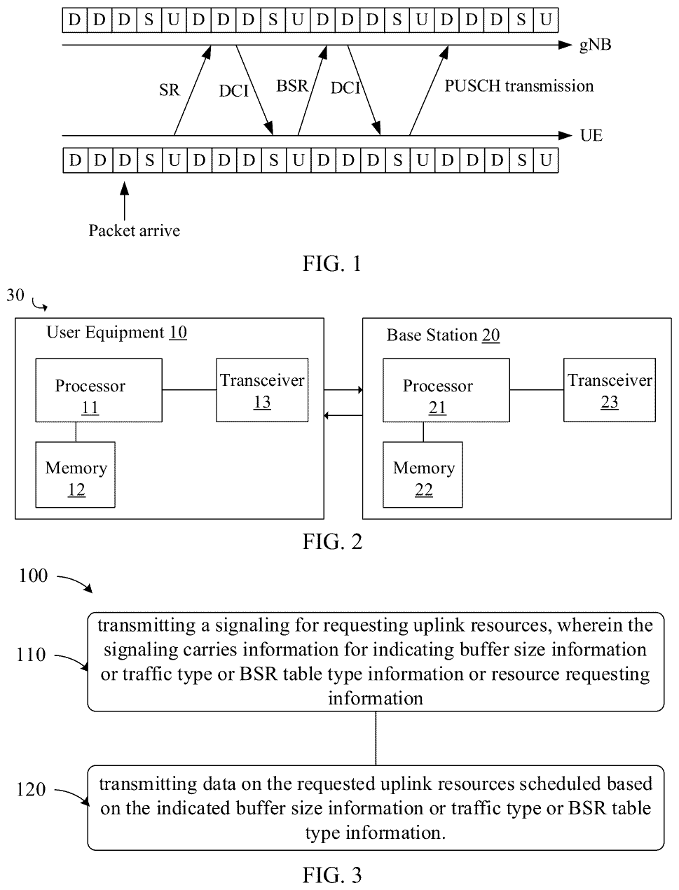

Latency is one of a key issue for XR service. In current 3GPP specification, a UL data transmission will be performed in a SR-BSR-PUSCH procedure as shown in FIG. 1. The function of scheduling request (SR) is just to request UL resources. If a packet is arrived at UE side, the UE needs to trigger SR. After SR is triggered, Buffer Status report (BSR) should be reported by the UE. After received the BSR from UE side, gNB can schedule a PUSCH transmission. In this case, the delay of SR+BSR is unavoidable, and it's more serious in Time Division Duplex (TDD) scenario. To reduce latency of the PUSCH transmission based on dynamic grant (DG) scheduling mechanism, potential enhancement will be needed. One straightforward way is to drop one or several steps of the DG scheduling mechanism, e.g., SR or BSR or both SR+BSR. However, if the step of triggering SR is dropped, a problem will be caused, that is, how does gNB know whether a UE requires UL resources or not. If the BSR reporting procedure is dropped, it will cause a problem of how does gNB know the buffer size from UE side. If both SR+BSR are dropped, a (multiple) configured grant resource(s) will be needed; however, this is not an efficient way of resource utilization, and it has been discussed and standardized in Rel-15. A straightforward way is to enhance the SR for the DG scheduling mechanism and combine the function of SR and BSR, e.g., a multiple-bit SR or a set of SR configurations or a SR that can convey extra information of buffer size. In addition, when the multiple-bit SR is configured, the mechanism for multiplexing SR and other types of Uplink Control Information (UCI), e.g., how to distinguish a legacy SR and an enhanced SR), should be studied.

Issue 1: Based on above analysis, an enhanced SR for DG scheduling mechanism can be studied, e.g., multiple-bit SR or a set of SR configurations. In addition, when the multiple-bit SR is configured, the mechanism for multiplexing SR and other types of UCI, e.g., how to distinguish a legacy SR and an enhanced SR, should be studied.

For XR service, a large buffer will be generated, and it results in requiring the BSR to indicate a high index from the existing BSR table. The higher the BSR index, the larger the buffer inaccuracy. This is because the BSR index indicates a range of values between X and Y, and the difference between X and Y is large. In current 3GPP specification, buffer sizes reported in BSR are coded by an exponential function, e.g., (Bₖ₊₁−Bₖ)/Bₖ is a constant for all k. N bits can be used to indicate the value of buffer size (e.g., 32 bits for short-BSR format and 256 bits for long-BSR format). The advantage of this encoding is that it provides a constant step size across all encoding points. The absolute value of step size is also an exponential function of k. As a result, this formula provides excellent granularity when k is small; however, the step size can grow exponentially fast as k increases. For example, at k=252, BS=76,380,419 bytes; at k=253, BS=81,338,368 bytes. Hence the step size=4,957,949 bytes. It means that when UE reports a buffer size of 81 MB, the actual buffer size can be 4.9 MB less than that. However, it's not suitable for XR services since a larger buffer size is always generated due to large data rate. Further, the coarse granularity will be caused due to over allocated resources or less allocated resources for XR service, and this will decrease the capability of UE. In addition, in current 3GPP specification, a BSR report only includes the BSR size of a logical channel group(s) and the same type of BSR table for a MAC CE can be mapped. There is no additional information for XR services that can be included, e.g., jitter. This hinders the UE capacity improvement. As a result, some potential enhancements will be needed. A straightforward way is to design a BSR type for XR and multiple BSR tables can be reported by UE. In addition, which and how extra information of XR can be reported by BSR can also be considered.

Issue 2: A BSR type for XR or multiple BSR types can be reported by UEs. In addition, which and how extra information of XR can be reported by BSR can also be considered.

The invention of this disclosure can be summarized as below:

This disclosure proposes approaches to support PUSCH that can be transmitted right after SR triggers. When gNB receives a SR from UE, after the processing time of SR, gNB can schedule a UE to transmit PUSCH without waiting for a BSR report.
Scheme 1: The buffer size information or XR traffic information can be indicated by SR explicitly, and SR can carry N bits, wherein N is an integer and can be configurable. When SR with multiple information bits is enabled, the multiplexing rules for SR and other type of UCIs are also given.
Scheme 2: Multiple types of SR can be configured simultaneously. Some SRs are legacy SR and some SRs are enhanced SR.
Scheme 3: The buffer size or traffic type carried by SR is associated with the time and frequency resources, wherein the time and frequency resources are configured to SR.

This disclosure also proposes potential approaches to support an enhanced BSR for XR services transmission. A XR specific BSR table is designed to achieve an accurate granularity of buffer size report, and some extra information of the traffic from UE side can be carried by BSR report.
Scheme 1: The type of BSR is indicated by SR. There is a bit in SR which is used for indicating the BSR type.
Scheme 2: The BSR type is associated with the time/frequency resources of SR, multiple frequency resources for a SR can be configured and different location of the time or frequency resources of the SR indicate a type of BSR implicitly.
Scheme 3: Introducing an additional field in MAC CE which is used to indicate the BSR type, wherein the additional field in MAC CE can be a fixed size or a configurable size.

The proposed schemes to support PUSCH that can be transmitted right after SR triggers can reduce scheduling delay, and the proposed potential schemes to support an enhanced BSR for XR service transmission can achieve accurate granularity of buffer size report.

FIG. 2 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

This disclosure proposes approaches to support PUSCH transmitted right after SR triggers. Specifically, when gNB receives a SR from UE, after the processing time of SR, gNB can schedule the UE to transmit PUSCH without waiting for a BSR report. In general, a SR does not have any bit used to indicate some buffer size information but only for resource request. In other word, SR is just used to tell gNB if there are data to be transmitted from UE side. For XR services, it includes multiple types of traffic, e.g., control or pose information, or video frame. Each traffic has its own Transport Block (TB) size. For instance, the size of pose or control information is small for most of the time, one scheduling can transmit a whole of the traffic, and the BSR does not have to be reported. The size of video traffic may be large and the latency of the traffic is small; in this case, the data and BSR can be transmitted together, so some TB size information should be indicated by the SR. Both explicit and implicit ways can be considered.

FIG. 3 is a flowchart of a wireless communication method according to a first embodiment of the present application. Referring to FIG. 3 in conjunction with FIG. 2, the method 100 includes the following. In Step 110, the UE transmits a signaling to the BS for requesting uplink resources, wherein the signaling carries information for indicating buffer size information or traffic type or Buffer Status Report (BSR) table type information or resource requesting information. The signaling may be a scheduling request (SR). The SR may carry zero or one or more bits for indicating the buffer size information or the traffic type or the BSR table type information. In Step 120, the UE transmits data on the requested uplink resources scheduled by the BS based on the indicated buffer size information or traffic type or BSR table type information. With this method, data can be transmitted right after SR, thereby reducing scheduling delay.

In an embodiment of the present application, a state represented by the zero or one or more bits of the SR indicates a range or an upper limit value of the buffer size information. Alternatively, a state represented by the one or more bits of the SR indicates that indicates resources for BSR is required to be scheduled. In an embodiment, the method includes transmitting multiple types of SR including the SR and a legacy SR. In an embodiment, the SR can be transmitted on different time and/or frequency resources, wherein the time and/or frequency resources of the SR indicate different BSR size or traffic type or BSR table type.

In an embodiment of the present application, when a transmission occasion of the SR is overlapped in time domain with Uplink Control Information (UCI) in a resource using a same Physical Uplink Control Channel (PUCCH) format, a priority rule is used to determine which one of the SR and the UCI is to be transmitted if the SR is a positive SR that requests resources for data transmission. In an example, which one of the SR and the UCI is transmitted is based on the priorities of the SR and the UCI, and a cyclic shift parameter used for the transmission is determined based on the one having a high priority. Alternatively, the UCI is transmitted using the PUCCH format for the UCI and a cyclic shift parameter used for the transmission is determined based on the SR. Alternatively, the UCI is transmitted using the PUCCH format for the SR and a cyclic shift parameter used for the transmission is determined based on the UCI. In an embodiment, when a transmission occasion of the SR is overlapped in time domain with UCI in a resource using a same PUCCH format, the UCI and the SR are combined and then transmitted using the PUCCH format, and each sequence from the combination of the UCI and the SR relates to a cyclic shift value. In an embodiment, when a transmission occasion of the SR is overlapped in time domain with UCI in a resource using a same PUCCH format, which one of the SR and the UCI is transmitted is based on which has an early symbol in the PUCCH format. In an embodiment, when a transmission occasion of the SR is overlapped in time domain with UCI in a resource using a same PUCCH format, the UCI is transmitted using the PUCCH format, and a cyclic shift parameter used for the transmission is determined based on a parameter different from the UCI. Further, the SR falls back to a SR that only indicates whether the UE has data to be transmitted, and the parameter for determining the cyclic shift parameter is associated with the SR.

In an embodiment of the present application, when a transmission occasion of the SR in a resource using a first PUCCH format is overlapped in time domain with UCI in a resource using a second PUCCH format, a PUCCH with the UCI in the resource using the second PUCCH format is transmitted if the SR is a negative SR; and a PUCCH with the SR in the resource using the first PUCCH format is transmitted if the SR is a positive SR. In an embodiment, when a transmission occasion of the SR in a resource using a first PUCCH format is overlapped in time domain with UCI in a resource using a second PUCCH format, which one of the SR and the UCI is transmitted is based on which has an early symbol in a corresponding PUCCH format. In an embodiment, when a transmission occasion of the SR in a resource using a first PUCCH format is overlapped in time domain with UCI in a resource using a second PUCCH format, the UCI and the SR are combined and then transmitted using the first PUCCH format or the second PUCCH format. In an embodiment of the present application, when a transmission occasion of the SR in a resource using a PUCCH format is overlapped in time domain with UCI in a resource using the same PUCCH format, a PUCCH with the UCI in the resource using the PUCCH format for the UCI is transmitted if the SR is a negative SR; and a PUCCH with the SR in the resource using the PUCCH format for the SR is transmitted if the SR is a positive SR. In an embodiment, when a transmission occasion of the SR in a resource using a PUCCH format is overlapped in time domain with UCI in a resource using the same PUCCH format, which one of the SR and the UCI is transmitted is based on which has an early symbol in a corresponding PUCCH format. In an embodiment, when a transmission occasion of the SR in a resource using a PUCCH format is overlapped in time domain with UCI in a resource using the same PUCCH format, which one of the SR and the UCI is transmitted is based on length of the SR and UCI in the PUCCH format if a start symbol of the SR and UCI is the same.

In a first possible implementation, the buffer size information or XR traffic information can be indicated by SR explicitly, and SR can carry N bits, wherein N is an integer and can be configurable. So, the total 2\hat{ }N states can be included and each state can indicate a range or an upper limit value of the buffer size information. As shown in table 1, each state (an index) of the SR can indicate a range of buffer size value or an upper limit value of the buffer size information, wherein the range of buffer size values or the upper limit value of the buffer size information is pre-configured. In some embodiments, the SR with multiple bits can be carried by any one of PUCCH formats, e.g., PUCCH format 0, PUCCH format 1, PUCCH format 2, PUCCH format 3, PUCCH format 4.

TABLE 1
2-bit SR and corresponding traffic size

| State (index) | Definition (bits) |
|---|---|
| 00 | 0~A-1 or A1 |
| 01 | A~B-1 or B1 |
| 10 | B~C-1 or C1 |
| 11 | >=C or D1 |

Furthermore, for some latency insensitive traffic unlike XR, e.g., eMBB, VOIP, it's no need to schedule PUSCH transmission right after SR, the general (SR+BSR+PUSCH) procedure is enough. A straightforward way is to introduce some states to present the function of general SR, wherein the general SR is a SR that does not carry the information of buffer size or traffic type, and for UL transmission, the SR+BSR+PUSCH procedure will be performed, as shown in table 2 or in table 3 or in table 4. Take the table 2 as an examples, the size of the SR is N bits, and a total number of 2\hat{ }N states can be used for SR indication. One among the total states is used to indicate a general negative SR (of course, when the SR is a negative SR, the SR cannot report the buffer size information or XR traffic information on the SR transmission occasion). One among the total states is used to indicate a general positive SR (e.g., a SR complies with the general (SR+BSR+PUSCH) procedure). The remaining states within the total states can be used to indicate the size of BSR or the traffic types. Take table 4 as another example, the size of the SR is 1, and the total number of 2 states can be used for SR indication. One among the total states is used to indicate a general positive SR and the other one among the total states is used to indicate a XR traffic, wherein the XR traffic means the gNB can schedule PUSCH transmission after a SR is triggered.

In some embodiments, when multiple bits of SR are configured to UE and the gNB does not detect SR information on a SR monitor occasion, the gNB regards the case as UE transmits a general negative SR.

TABLE 2
N(=2)-bit SR and corresponding traffic size

| State (index) | Definition |
|---|---|
| 00 | General negative SR |
| 01 | General positive SR |
| 10 | 0~A-1 |
| 11 | >=A |

TABLE 3
N(=2)-bit SR and corresponding traffic size

| State (index) | Definition (bits) |
|---|---|
| 00 | General positive SR |
| 01 | 0~A-1 |
| 10 | A~B-1 |
| 11 | >=B |

TABLE 4
N(=1)-bit SR and corresponding traffic size

| State (index) | Definition (bits) |
|---|---|
| 0 | General positive SR |
| 1 | XR traffic |

In addition, when multiple bits of SR are configured and the SR transmission is overlapped with other UCI transmission in time domain, the rules for multiplexing Uplink Control Information (UCI) and SR are not suitable anymore. Some enhanced approaches to handle the UCI and SR multiplexing is needed. The following scenarios and approaches can be considered.

In a first case, a PUCCH with negative (multiple bits) SR and at most 2 HARQ-ACK information bits in a resource using PUCCH format 0 in a slot. In this case, UE only transmits the HARQ-ACK using the PUCCH format 0 and the cyclic shift parameter is determined based on HARQ-ACK. When a SR transmission occasion is overlapped with at most 2 HARQ-ACK information bits in a resource using PUCCH format 0 in time domain, the UE transmits HARQ-ACK information (sequence) only based on HARQ-ACK parameters and the gNB regards the SR is a negative SR, that is, not requesting resources for data transmission.

In a second case, A PUCCH with positive SR (multiple bits) and at most 2 HARQ-ACK information bits in a resource using PUCCH format 0 in a slot. In this case, both SR and HARQ-ACK have its cyclic shift values, where the cyclic shift values can be pre-defined. Due to limitation of cyclic shift values, priority rules can be introduced for handing the case. The following alternatives can be considered.

In a first alternative implementation, regard positive SR as high priority and the HARQ-ACK transmission as low priority, UE transmits positive SR using the PUCCH format 0 for SR and the cyclic shift parameter is determined based on positive SR configuration. In some embodiments, the HARQ-ACK is dropped, or postpone the HARQ-ACK to the next (available) transmission occasion.

In a second alternative implementation, regard HARQ-ACK transmission as high priority and the SR report as low priority. UE transmits HARQ-ACK using the PUCCH format 0 for HARQ-ACK and the cyclic shift parameter is determined based on only HARQ-ACK report parameters. In some embodiments, the SR is dropped, or postpone the SR report to the next (available) transmission occasion.

In a third alternative implementation, regard HARQ-ACK transmission as high priority and the SR report as low priority (in this case, the SR does not carry buffer size or traffic type information anymore, it can fall back to general SR, which means the SR is just only to require UL resource and not to enable SR+PUSCH transmission). UE transmits HARQ-ACK using the PUCCH format 0 for HARQ-ACK and the cyclic shift parameter is determined based on SR.

In a fourth alternative implementation, regard HARQ-ACK transmission as high priority and the SR report as low priority (in this case, the SR does not carry buffer size or traffic type information anymore, it can fall back to general SR, which means the SR is just only to require UL resource and not to enable SR+PUSCH transmission). UE transmits HARQ-ACK using the PUCCH format 0 for SR and the cyclic shift parameter is determined based on HARQ-ACK.

In a fifth alternative implementation, regard HARQ-ACK transmission and SR report as the same priority, and introduce a new cyclic shift parameter for combining the SR and HARQ-ACK.

For 1-bit HARQ-ACK and 1-bit SR, a new table for one HARQ-ACK information bit and one SR information bit to make a data sequence for PUCCH format 0 is designed. Each cyclic shift value can indicate one combination of SR and HARQ-ACK information. For instance, as shown in table 5, when a sequence from the combination of HARQ-ACK and SR uses m_{cs}=0, it means the HARQ-ACK is 0 and the SR is 0; when a sequence from the combination of HARQ-ACK and SR uses m_{cs}=2, it means the HARQ-ACK is 0 and the SR is 1; when a sequence from the combination of HARQ-ACK and SR uses m_{cs}=6, it means the HARQ-ACK is 1 and the SR is 0; when a sequence from the combination of HARQ-ACK and SR uses m_{cs}=7, it means the HARQ-ACK is 1 and the SR is 1. In some embodiments, the value of m_{cs} in table 5 can be configurable.

TABLE 5
Mapping of values for one HARQ-ACK information bit and
one SR information bit to sequences for PUCCH format 0

| [HARQ-ACK Value, | | | | |
|---|---|---|---|---|
| SR Value] | [0, 0] | [0, 1] | [1, 0] | [1, 1] |
| Sequence cyclic shift | m_{cs} = 0 | m_{cs} = 2 | m_{cs} = 6 | m_{cs} = 7 |

For 2-bit HARQ-ACK and 1-bit SR, a new table for 2 HARQ-ACK information bits and one SR information bit to make a data sequence for PUCCH format 0 is designed. Each cyclic shift value can indicate one combination of SR and HARQ-ACK information. For instance, as shown in table 6, when a sequence from the combination of HARQ-ACK and SR uses m_{cs}=0, it means the HARQ-ACK is {0,0} and the SR is 0; when a sequence from the combination of HARQ-ACK and SR uses m_{cs}=1, it means the HARQ-ACK is {0, 1} and the SR is 0; when a sequence from the combination of HARQ-ACK and SR uses m_{cs}=2, it means the HARQ-ACK is {1,0} and the SR is 0; when a sequence from the combination of HARQ-ACK and SR uses m_{cs}=3, it means the HARQ-ACK is {0,1} and the SR is 1; when a sequence from the combination of HARQ-ACK and SR uses m_{cs}=4, it means the HARQ-ACK is {1,0} and the SR is 0; when a sequence from the combination of HARQ-ACK and SR uses m_{cs}=5, it means the HARQ-ACK is {1,0} and the SR is 1; when a sequence from the combination of HARQ-ACK and SR uses m_{cs}=6, it means the HARQ-ACK is {1,1} and the SR is 0; when a sequence from the combination of HARQ-ACK and SR uses m_{cs}=7, it means the HARQ-ACK is {1,1} and the SR is 1. In some embodiments, the value of m_{cs} in table 6 can be configurable.

TABLE 6
Mapping of values for one HARQ-ACK information bit and
one SR information bit to sequences for PUCCH format 0

| [HARQ-ACK | | | | | | | | |
|---|---|---|---|---|---|---|---|---|
| Value, SR | | | | | | | | |
| Value] | [{0, 0}, 0] | [{0, 0}, 1] | [{0, 1}, 0] | [{0, 1}, 1] | [{1, 0}, 0] | [{1, 0}, 1] | [{1, 1}, 0] | [{1, 1}, 1] |
| Sequence | m_{cs} = 0 | m_{cs} = 1 | m_{cs} = 2 | m_{cs} = 3 | m_{cs} = 4 | m_{cs} = 5 | m_{cs} = 6 | m_{cs} = 7 |
| cyclic shift | | | | | | | | |

For up to 2 bits HARQ-ACK and N bits SR, a new table for 1˜2 HARQ-ACK information bit and N SR information bits to make a sequence for PUCCH format 0 is designed. Each cyclic shift value can indicate one combination of SR and HARQ-ACK information. In some embodiments, the value of m_{cs} in the table can be configurable.

In a sixth alternative implementation, UE transmits the PUCCH format 0 and corresponding information which has an early symbol. For instance, if the first symbol of PUCCH format 0 for HARQ-ACK is earlier than the PUCCH format 0 for SR, then UE transmits the HARQ-ACK; if the first symbol of PUCCH format 0 for HARQ-ACK is later than the PUCCH format 0 for SR, then UE transmits the SR.

In a third case, a PUCCH with multiple-bit SR information and at most 2 HARQ-ACK information bits in a resource using PUCCH format 0 with different priority in a slot, wherein the priority is configured by gNB. For the case the SR with high priority and the HARQ-ACK with low priority, UE should report SR to the gNB and drop the HARQ-ACK or postpone HARQ-ACK to the next (available) transmission occasion. For the case the HARQ-ACK with high priority and the SR with low priority, the UE should report HARQ-ACK using the PUCCH format 0 and the cyclic shift parameter is determined based on only HARQ-ACK and drop the SR or postpone SR to the next (available) transmission occasion. In some embodiments, UE transmits HARQ-ACK using the PUCCH format 0 and the cyclic shift parameter is determined based on a new parameter different from the only HARQ-ACK report parameter. In this situation, the multiple-bit SR falls back to the positive SR, the SR just indicates whether the UE has data to be transmitted or not but does not indicate extra information (buffer size information) anymore. The new parameter is associated with the positive SR. In this way, a positive SR and HARQ-ACK are reported to gNB.

In a fourth case, for the case that a UE would transmit multiple-bit SR in a resource using PUCCH format 0 and HARQ-ACK information bits in a resource using PUCCH format 1 in a slot, both of the SR and the HARQ-ACK are with same priority. The following alternatives can be considered.

In a first alternative implementation, if the SR is a negative SR, then UE transmits only a PUCCH with HARQ-ACK information bits in the resources using PUCCH format 1. If the SR is a positive SR, then UE transmits only a PUCCH with SR bits in the resources using PUCCH format 0.

In a second alternative implementation, which one of SR and HARQ-ACK information UE reports is based on the first symbol of each PUCCH format. If the first symbol of PUCCH format 0 is earlier than PUCCH format 1, then UE transmits only a PUCCH with SR information bits in a resource using PUCCH format 0. If the first symbol of PUCCH format 1 is earlier than PUCCH format 0, then UE transmits only a PUCCH with HARQ-ACK information bits in a resource using PUCCH format 1. If the first symbol of each PUCCH format is the same and UE transmit the information bits using a PUCCH format which has short symbols.

In a fifth case, for the case that a UE would transmit multiple-bit SR information in a resource using PUCCH format 1 and up to 2 HARQ-ACK information bits in a resource using PUCCH format 0 in a slot, the SR and the HARQ-ACK are with same priority. The following alternatives can be considered.

In a first alternative implementation, if the SR is a negative SR, then UE transmits only a PUCCH with HARQ-ACK information bits in the resources using PUCCH format 0. In this way, the gNB regards UE has a negative SR.

In a second alternative implementation, if the SR is a positive SR, then UE transmits only a PUCCH with SR bits in the resources using PUCCH format 1.

In a third alternative implementation, a new cyclic shift value table can be designed to combine the SR and HARQ-ACK transmission, PUCCH format 0 is used to transmit the combined information.

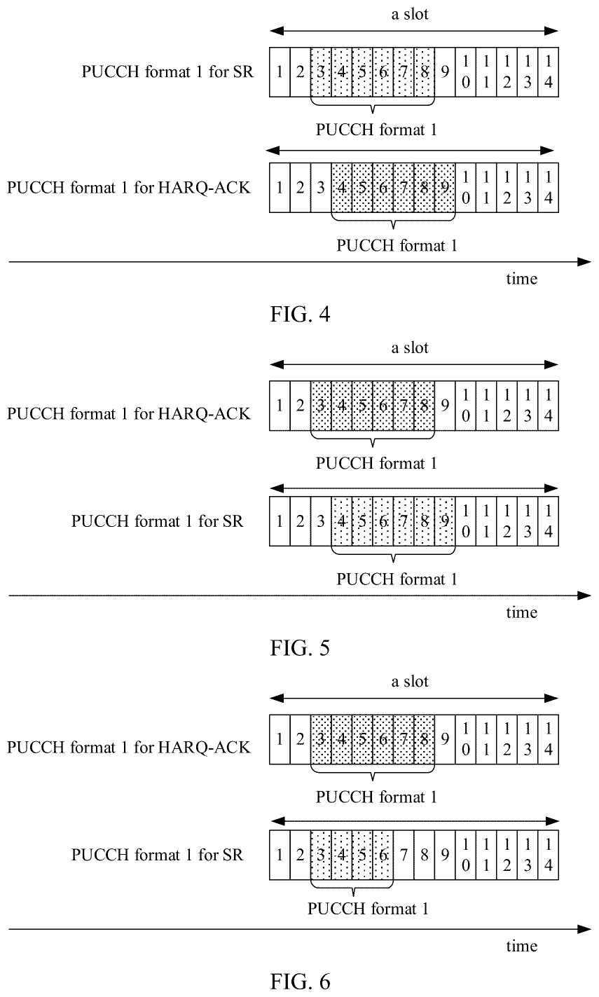

In a sixth case, for the case a UE would transmit multiple-bit SR in a resource using PUCCH format 1 and at most two HARQ-ACK information bits in a resource using PUCCH format 1 in a slot, if the UE transmits a negative SR, then UE transmits a PUCCH in the resource using PUCCH format 1 for HARQ-ACK information; and if the UE transmits a positive SR, then UE transmits a PUCCH in the resource using PUCCH format 1 for SR information and/or postpone the HARQ-ACK to the next (available) transmission occasion. In some embodiments, the UE transmits a PUCCH for SR or HARQ-ACK, which is based on the time location of the PUCCH. If the first symbol of PUCCH format 1 for HARQ-ACK is earlier than PUCCH format 1 for SR, then UE transmits only a PUCCH with HARQ-ACK information bits in a resource using PUCCH format 1, as shown in FIG. 4. The first symbol of PUCCH format 1 for SR is symbol #3 and the first symbol of PUCCH format 1 for HARQ-ACK is symbol #4 in a slot, and the UE transmits a PUCCH in the resource using PUCCH format 1 for SR.

If the first symbol of PUCCH format 1 for SR is earlier than PUCCH format 1 for HARQ-ACK, then UE transmits only a PUCCH with SR information bits in a resource using PUCCH format 1, as shown in FIG. 5. The first symbol of PUCCH format 1 for SR is symbol #4 and the first symbol of PUCCH format 1 for HARQ-ACK is symbol #3 in a slot, and the UE transmit a PUCCH in the resource using PUCCH format 1 for HARQ-ACK.

If the first symbol of each PUCCH format is the same, then UE transmits the information bits using a PUCCH format which has short symbols. As shown in FIG. 6, the first symbol of PUCCH format 1 for SR and the first symbol of PUCCH format 1 for HARQ-ACK is the same in a slot, and the length of PUCCH format 1 for SR is short than the PUCCH format 1 for HARQ-ACK, then UE transmits a PUCCH in the resource using PUCCH format 1 for SR.

In a seventh case, a UE would transmit a PUCCH with HARQ-ACK or/and CSI information bits (denoted as M) in a resource using PUCCH format 2 or PUCCH format 3 or PUCCH format 4 and transmit K+N PUCCHs for respective K+N SRs in a slot. The information bits of SRs in a resource uses PUCCH format 0 or PUCCH format 1. The number of N SRs includes multiple information bits and we set the total size of the information bits of N SRs is A. The number of the remaining of SRs is K and the K SRs do not carry multiple information bits. Then the UE transmits the combined (M+A) UCI bits in a PUCCH using a resource with PUCCH format 2 or PUCCH format 3 or PUCCH format 4. In some embodiments, the UE transmits the combined (M+A+ceil [log 2 (k+1)]) UCI bits in a PUCCH using a resource with PUCCH format 2 or PUCCH format 3 or PUCCH format 4.

In an eighth case, A UE would transmit a PUCCH with HARQ-ACK or/and CSI information bits (denoted as M) in a resource using PUCCH format 2 or PUCCH format 3 or PUCCH format 4 and transmit K+N PUCCHs for respective K+N SRs in a slot. The information bits of SRs in a resource uses PUCCH format 0 or PUCCH format lor PUCCH format 3 or PUCCH format 2 or PUCCH format 4. The number of N SRs includes multiple information bits and we set the total size of the information bits of N SRs is A. The number of the remaining of SRs is K and the K SRs do not carry multiple information bits. Then the UE transmits the combined (M+A) UCI bits in a PUCCH using a resource with PUCCH format 2 or PUCCH format 3 or PUCCH format 4 which has an early symbol. In some embodiments, the UE transmits the combined (M+A+ceil [log 2 (k+1)]) UCI bits in a PUCCH using a resource with PUCCH format 2 or PUCCH format 3 or PUCCH format 4.

In a second possible implementation, multiple types of SR can be configured simultaneously. Some SRs are legacy SR and some SRs are enhanced SR. For example, the legacy SR is the SR in Rel-15˜17. This type of SR is just for requesting UL resources and only tells gNB whether the UE has data to be transmitted or not, and for a UL transmission, the procedure of SR+BSR+PUSCH will be encountered. The enhanced SR carries multiple information bits and indicates some information of the traffic from UE side, e.g., traffic types or the buffer size of the traffic. In some embodiments, when different types of SRs are overlapped in time domain, the UE would transmit the enhanced SR using PUCCH format 0 or PUCCH format 1 or PUCCH format 2 or PUCCH format 3 or PUCCH format 4.

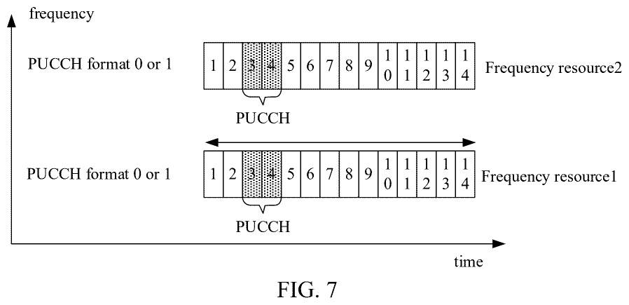

In a third possible implementation, the buffer size or traffic type carried by SR is associated with the time and frequency resources, wherein the time and frequency resources are configured to SR. A same PUCCH format with different time and/or frequency resources can carry the buffer size or traffic type information. For instance, as shown in FIG. 7, a same PUCCH format is configured for SR reporting with different frequency resources. When UE reports SR at the PUCCH format 0 or 1 using frequency resource 1, it means a legacy SR is transmitted and the procedure of SR+BSR+PUSCH is performed for PUSCH transmission. When UE reports SR at the PUCCH format 0 or 1 using frequency resource 2, it means an SR with traffic type or buffer size is transmitted and the procedure of SR+PUSCH is performed for PUSCH transmission. Similar mechanism can be reused for other PUCCH formats.

This disclosure proposes potential approaches to support an enhanced BSR for XR services transmission. A XR specific BSR table is designed to achieve accurate granularity of buffer size report, and some extra information of the traffic from UE side can be carried by BSR report. In current 3GPP specification, buffer sizes reported in BSR are coded by an exponential function, e.g. (Bₖ₊₁−Bₖ)/Bₖ which is a constant for all k. When the index of BSR is small, the difference between X and Y is also small; however, when the index is large, then the difference between X and Y is large. One of potential approaches is to split the current BSR table into multiple parts such that the (Bₖ₊₁−Bₖ)/Bₖ has a different value for all k among the multiple parts. The step value of each part and the range of each parts can be configurable or pre-defined. When the index increases, the (Bₖ₊₁−Bₖ)/Bₖ decreases. In other words, for the small buffer size within the BSR table, the (Bₖ₊₁−Bₖ)/Bₖ value can be set with a big value, and for the large buffer size within the BSR table, the (Bₖ₊₁−Bₖ)/Bₖ value can be set with a corresponding small value.

In addition, for multiple traffic flows of XR service, some traffic of the XR has a small packet size and low latency and some traffic of the XR services has a huge packet size and low latency. However, different types of XR services have various requirements and the procedure of each type of XR service may be different, e.g., when PUSCH scheduling right after SR triggers is enabled, whether the BSR report is needed or not would be determined. For a large packet size of a traffic, a subsequent scheduling transmission cannot completely transmit whole buffer size of the traffic, but for a small packet size of a traffic, a subsequent scheduling transmission is enough to transmit whole buffer size of the traffic. In the later case, the BSR is not needed. As a result, the association relationship between SR and BSR (type) or whether BSR exists or not would also be determined.

In an embodiment of the present application, the SR indicates the buffer size information according to a buffer status report (BSR) table or a legacy BSR table. Further, the BSR table includes multiple parts, and a ratio of a range of buffer sizes of each of the multiple parts to an extreme value of the range is not a constant, and wherein the greater the buffer size is, the smaller the ratio is. In an embodiment, a state represented by the one or more bits of the SR indicates a type of BSR table. Alternatively, a state represented by the one or more bits of the SR indicates whether BSR needs to be transmitted or not. Alternatively, a state represented by the one or more bits of the SR indicates a type of BSR table and whether BSR needs to be transmitted or not. In an embodiment, the SR can be transmitted on different time and/or frequency resources, wherein the time and/or frequency resource of the SR indicate different types of BSR table. In an embodiment, the method further includes: receiving a Media Access Control (MAC) Control Element (CE) with a field indicating a type of BSR table that the buffer size information is referred to.

In a first possible implementation, the type of BSR is indicated by SR. There is a bit in SR which is used for indicating the BSR type. For instance, as shown in table 7. There is a bit in SR which is used to indicate the type of BSR. The state of 0 in SR indicates a legacy BSR table, and the state of 1 in SR indicates an enhanced BSR table.

TABLE 7
1 bit within SR to indicate the BSR table

| State (index) | Definition (bits) |
|---|---|
| 0 | Legacy BSR |
| 1 | Enhanced BSR |

In some embodiments, whether the UE needs to report BSR or not also needs to be determined since some traffic load will be small. Whether the BSR needs to be transmitted or not can be a code point within a table. One state of SR can indicate the BSR type and whether it needs to report the BSR or not, as shown in table 8. We take 2 bit within SR as an example, state “00” indicates the legacy BSR and the BSR is not needed to be reported, state “01” indicates the enhanced BSR table and the BSR is not needed to be reported, state “10” indicates the legacy BSR table and the BSR needs to be reported, and state “11” indicates the enhanced BSR table and the BSR needs to be reported.

TABLE 8
2 bits within SR to indicate the BSR table

| | | BSR needs to be |
|---|---|---|
| State (index) | Definition (bits) | reported or not |
| 00 | Legacy BSR | Not report |
| 01 | Enhanced BSR | Not report |
| 10 | Legacy BSR | Report |
| 11 | Enhanced BSR | Report |

In a second possible implementation, the BSR type is associated with the time/frequency resources of SR. Multiple frequency resources for a SR can be configured and different location of the time and/or frequency resources of the SR can be used to indicate the type of BSR implicitly. For example, when UE reports SR using first frequency resource, it implies the legacy BSR table is to be used; When UE reports SR using second frequency resource, it implies the enhanced BSR table is to be used.

In a third possible implementation, introducing an additional field in MAC CE which is used to indicate the BSR type, wherein the additional field in MAC CE can be a fixed size or a configurable size. For instance, as shown in table 9, taking the size of the additional field as an example, the state of 0 indicates the legacy BSR table, and the state of 1 indicates the enhanced BSR table.

TABLE 9
An additional field in MAC CE to indicate the BSR table

| State | Definition (bits |
|---|---|
| 0 | Legacy BSR |
| 1 | Enhanced BSR |

For the case multiple SRs are associated to the multiple types of BSR tables, one straightforward way is to configure a table to UE and the table defines the relationship of each state of SR and the BSR type. As shown in table 4, total 1 bit of information is carried by SR. State of 0 in SR indicates the SR is related to the legacy BSR, and the reported BSR uses the table of BSR in Rel-15˜17, for example. State of 1 in SR indicates the SR is related to the enhanced BSR, and the enhanced BSR is more suitable for XR services. In some embodiments, the enhanced BSR includes other information such as jitter value, PDB, traffic arrive periodicity, etc.

Commercial interests for some embodiments are as follows. 1. Solving issues in the prior art. 2. Reducing scheduling delay. 3. Achieving accurate granularity of buffer size report. 4. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A wireless communication method, performed by a user equipment (UE) in a network, the method comprising:
transmitting a signaling for requesting uplink resources, wherein the signaling carries information for indicating buffer size information or traffic type or Buffer Status Report (BSR) table type information or resource requesting information; and
transmitting data on the requested uplink resources scheduled based on the indicated buffer size information or traffic type or BSR table type information.

2. The method of claim 1, wherein the signaling is a scheduling request (SR), and the SR carries zero or one or more bits for indicating the buffer size information or the traffic type or the BSR table type information.

3. The method of claim 2, wherein a state represented by the zero or one or more bits of the SR indicates a range or an upper limit value of the buffer size information.

4. The method of claim 2, wherein a state represented by the one or more bits of the SR indicates that indicates resources for BSR is required to be scheduled.

5. (canceled)

6. The method of claim 2, wherein the SR can be transmitted on different time and/or frequency resources, wherein the time and/or frequency resources of the SR indicate different BSR size or traffic type or BSR table type.

7. The method of claim 2, wherein when a transmission occasion of the SR is overlapped in time domain with Uplink Control Information (UCI) in a resource using a same Physical Uplink Control Channel (PUCCH) format, a priority rule is used to determine which one of the SR and the UCI is to be transmitted if the SR is a positive SR that requests resources for data transmission.

8. The method of claim 7, wherein which one of the SR and the UCI is transmitted is based on the priorities of the SR and the UCI, and a cyclic shift parameter used for the transmission is determined based on the one having a high priority.

9. The method of claim 7, wherein the UCI is transmitted using the PUCCH format for the UCI and a cyclic shift parameter used for the transmission is determined based on the SR.

10. The method of claim 7, wherein the UCI is transmitted using the PUCCH format for the SR and a cyclic shift parameter used for the transmission is determined based on the UCI.

11. The method of claim 2, wherein when a transmission occasion of the SR is overlapped in time domain with UCI in a resource using a same PUCCH format, the UCI and the SR are combined and then transmitted using the PUCCH format, and each sequence from the combination of the UCI and the SR relates to a cyclic shift value.

12. The method of claim 2, wherein when a transmission occasion of the SR is overlapped in time domain with UCI in a resource using a same PUCCH format, which one of the SR and the UCI is transmitted is based on which has an early symbol in the PUCCH format.

13. The method of claim 2, wherein when a transmission occasion of the SR is overlapped in time domain with UCI in a resource using a same PUCCH format, the UCI is transmitted using the PUCCH format, and a cyclic shift parameter used for the transmission is determined based on a parameter different from the UCI.

14. (canceled)

15. The method of claim 2, wherein when a transmission occasion of the SR in a resource using a first PUCCH format is overlapped in time domain with UCI in a resource using a second PUCCH format, a PUCCH with the UCI in the resource using the second PUCCH format is transmitted if the SR is a negative SR; and a PUCCH with the SR in the resource using the first PUCCH format is transmitted if the SR is a positive SR.

16. The method of claim 2, wherein when a transmission occasion of the SR in a resource using a first PUCCH format is overlapped in time domain with UCI in a resource using a second PUCCH format, which one of the SR and the UCI is transmitted is based on which has an early symbol in a corresponding PUCCH format.

17. The method of claim 2, wherein when a transmission occasion of the SR in a resource using a first PUCCH format is overlapped in time domain with UCI in a resource using a second PUCCH format, the UCI and the SR are combined and then transmitted using the first PUCCH format or the second PUCCH format.

18. The method of claim 2, wherein when a transmission occasion of the SR in a resource using a PUCCH format is overlapped in time domain with UCI in a resource using the same PUCCH format, a PUCCH with the UCI in the resource using the PUCCH format for the UCI is transmitted if the SR is a negative SR; and a PUCCH with the SR in the resource using the PUCCH format for the SR is transmitted if the SR is a positive SR.

19. (canceled)

20. The method of claim 2, wherein when a transmission occasion of the SR in a resource using a PUCCH format is overlapped in time domain with UCI in a resource using the same PUCCH format, which one of the SR and the UCI is transmitted is based on length of the SR and UCI in the PUCCH format if a start symbol of the SR and UCI is the same.

21-26. (canceled)

27. The method of claim 1, further comprising:
receiving a Media Access Control (MAC) Control Element (CE) with a field indicating a type of BSR table that the buffer size information is referred to.

28. A wireless communication method, performed by a base station (BS) in a network, the method comprising:
receiving a signaling used to request uplink resources, wherein the signaling carries information for indicating buffer size information or traffic type or Buffer Status Report (BSR) table type information or resource requesting information; and
receiving data transmitted on the requested uplink resources scheduled based on the indicated buffer size information or traffic type or BSR table type information.

29-53. (canceled)

54. The method of claim 28, further comprising:
transmitting a Media Access Control (MAC) Control Element (CE) with a field indicating a type of BSR table that the buffer size information is referred to.

55. A user equipment (UE), comprising a processor and a transmitter, wherein the processor is configured to call and run program instructions stored in a memory, to cooperate with the transmitter to execute operations comprising:
transmitting a signaling for requesting uplink resources, wherein the signaling carries information for indicating buffer size information or traffic type or Buffer Status Report (BSR) table type information or resource requesting information; and
transmitting data on the requested uplink resources scheduled based on the indicated buffer size information or traffic type or BSR table type information.

56. (canceled)
